(19) United States
(12) Patent Application Publication
(10) Pub. No.: US 2009/0303891 A1
(43) Pub. Date: Dec. 10, 2009

(54) Mobile Station and Method Therefor Using Doppler and Cell Transition History for Cell Evaluation in a Fast Moving Environment

(75) Inventors: Richard C. Lucas, Ash Vale (GB); David N. Freeman, Basingstoke (GB)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/134,450

(22) Filed: Jun. 6, 2008

(51) Int. Cl. H04L 12/26

(52) U.S. Cl. 370/252

(57) ABSTRACT

There is disclosed, a mobile station, and a method for candidate cell evaluation in a fast moving environment. The method includes receiving a plurality of transmissions from a plurality of candidate cells, where each of the plurality of transmissions corresponds to one of the plurality candidate cells. The method further includes measuring signal strengths of the plurality of transmissions and determining change in the signal strengths of the plurality of transmissions. The method further includes calculating a weighting factor corresponding to the plurality of candidate cells based on the measured signal strengths, the change in the signal strength, and a Doppler and assigning priority levels to the plurality of candidate cells based on the calculated weighting factor.

### FIELD OF THE DISCLOSURE

The present disclosure relates generally to wireless communication networks and more particularly to mobile station and method therefore using Doppler and cell transition history for cell evaluation in a fast moving environment.

### BACKGROUND

Mobile stations in wireless telecommunication networks perform cell selection and reselection based on various criteria such as Radio Signal Strength Indication (RSSI) which is a measurement of the radio signal strength from a base station, also referred to as a “base transceiver stations (BTS), Node-B, or cell, at a receiving antenna of a mobile station. As the mobile station travels through various radio coverage areas, which are defined by the radio coverage areas of the various BTSs, either the network sends, or the mobile station itself defines, a “neighbor list” update. The neighbor list provides cell identifications and other information related to BTS (or cells) nearby the location of the mobile station, and near the mobile station's current serving cell. The primary purpose of the neighbor list is to provide the mobile station with a list of candidate cells for handover when the signal reception from the current serving cell degrades to an unacceptable level.

The neighbor list candidates prove acceptable for handovers for mobile stations moving at a relatively slow pace through the network, for example, by being carried by the user walking through the coverage areas, or even for users in automobiles moving at relatively low rates of speed in high traffic conditions.

However, for large number of users moving at approximately the same time, or for individual users moving at high rates of speed, difficulties arise with cell reselection and handover. For example, handover for a mobile station on a moving train would be especially problematic. As the mobile station measured the RSSI from a cell and added it to the neighbor list as a handover candidate, the mobile station may have already moved outside the cell's radio coverage area, under a fast moving environment. Therefore the mobile station could lose cell handover candidates almost as quickly as it was able to perceive and measure their respective signal levels. Also during instances when a number of users approach for a handover and there is a limit to the number of handover opportunities into a new cell, the mobile station may loose the opportunity to have a successful handover.

The time that the mobile station has to measure data is a primary limitation on this particular performance aspect. The mobile station in fact has a limited number of search frames and frames on which to perform measurements.

Therefore, there is a need for a method for using Doppler and cell transition history for cell evaluation in a fast moving environment.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating cells perceived by a mobile station on a moving train in accordance with some embodiments.

FIG. 2 illustrates a Time Division Multiple Access (TDMA) duplex frame in accordance with some embodiments.

FIG. 3 illustrates a time gap between successive TDMA duplex frames in accordance with some embodiments.

FIG. 4 illustrates a traffic channel (TCH) multi-frame and its relationship to a Broadcast Control Channel (BCCH) multi-frame in accordance with some embodiments.

FIG. 5 is a table corresponding to a neighbor list in accordance with some embodiments.

FIG. 6 is a block diagram of a mobile station in accordance with some embodiments.

FIG. 7 is a flow diagram describing a basic operation of the mobile station of FIG. 6 in accordance with some embodiments.

FIG. 8 is a flow diagram describing a detailed operation of the mobile station of FIG. 6 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, a method enables a mobile station to perform candidate cell evaluation in a fast moving environment. The method includes receiving a plurality of transmissions from a plurality of candidate cells, where each of the plurality of transmissions corresponds to one of the plurality candidate cells. The method further includes measuring signal strengths of the plurality of transmissions and determining a change in the signal strengths of the plurality of transmissions. The method further includes calculating a weighting factor corresponding to the plurality of candidates cells based on the measured signal strength, the change in the signal strength, and a Doppler effect and assigning priority levels to the plurality of candidate cells based on the calculated weighting factor. Advantages of the various embodiments include: reduced incidents of call drops for fast moving wireless communication devices; reduced number of handovers in a fast moving environment; increased reliability and robustness of the wireless communication devices; and reduced load on a control channel. Those skilled in the art will realize that the above recognized advantages and other advantages described herein are merely illustrative and are not meant to be a complete rendering of all of the advantages of the various embodiments.

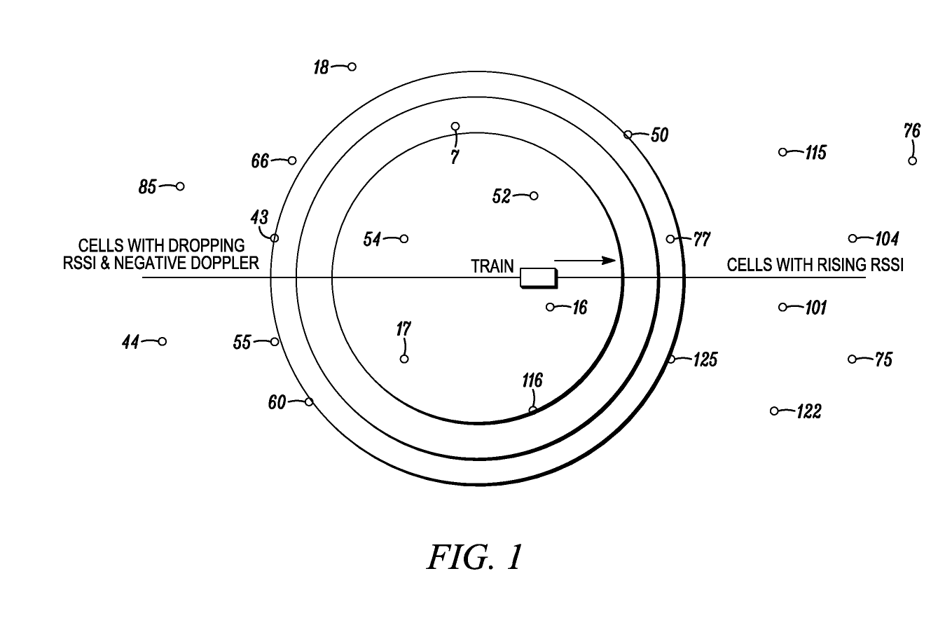

Referring now to figures, FIG. 1 illustrates the perception of communication network cells by a mobile station traveling on a train at a fast rate of speed. The node numbers illustrated represent the “Absolute Radio Frequency Channel Number” (ARFCN) of the respective cells. As the train moves forward along the horizontal axis as shown, the Radio Signal Strength Indication (RSSI) of the cells in front of the train, or nearest to the train as it passes, will be perceived by the mobile station as increasing, while the cells behind the train will be perceived as decreasing. Therefore the cells within the concentric circles represent the cells perceptible to the mobile station at a point in time, where the three concentric circles represent varying levels of RSSI, with the innermost being the strongest and the outermost being the weakest. Because the mobile station is taking measurements at different points in time and then reporting those measurements to the network, it can be observed from FIG. 1 that the mobile station is reporting historical data. The data is historical because as the mobile station leaves the concentric circles shown, some cells will fall outside of the mobile stations perceptible range. Therefore, many of the cells that are reported as candidates for handover will in fact no longer be candidates should the mobile station need to perform a cell reselection and handover.

As illustrated by FIG. 1, cells shown on the left side of the train are with dropping RSSI and negative Doppler. In contrast, cells shown on the right side of the train are with rising RSSI and positive Doppler. Therefore, the mobile station, in accordance with the various embodiments, synchronizes the cells with the rising RSSI and positive Doppler, in contrast to the cells with dropping RSSI and negative Doppler. The mobile station, in this case, may recognize that it is in a fast moving environment by measuring a change in the measured RSSI values.

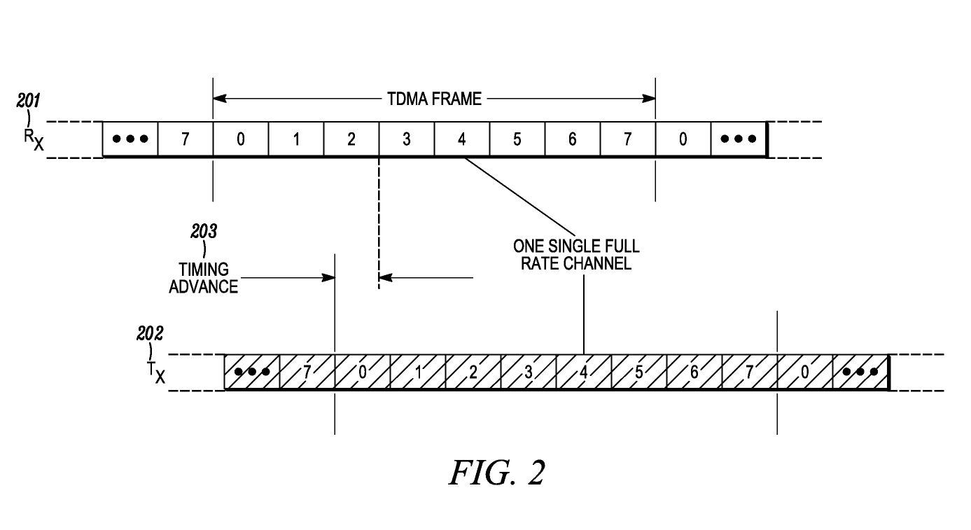

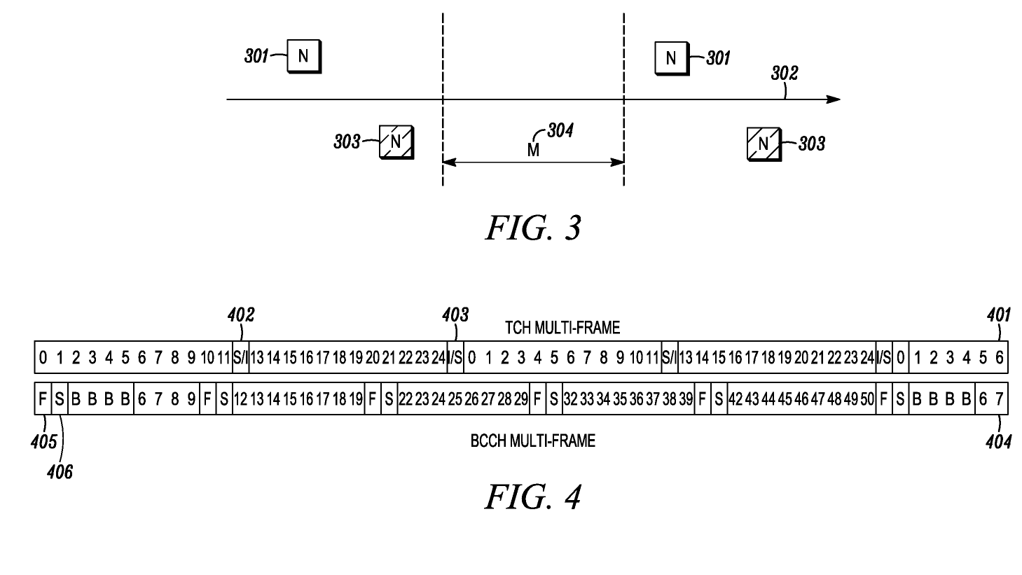

FIG. 2 and FIG. 3 illustrate a Time Division Multiple Access (TDMA) full duplex frame and timing involved in cell measurements by the mobile station. According to FIG. 2, a receive (Rx) Time Domain Multiple Access (TDMA) frame 201 and a TDMA transmit (Tx) frame 202 are shown in which one single full rate channel is defined by a timeslot in the Rx frame 201 and the Tx frame 202 thereby forming a full duplex channel. A timing advance 203 is also applied to account for radio propagation delay between the mobile station and the base transceiver station which forms the cell.

As can be seen from FIG. 2, for any timeslot “n” in a full rate traffic channel, the normal pattern is a receive timeslot (such as Rx timeslot 4) followed by two time slots, for example two Rx frame 201 timeslots (less the timing advance) followed by a transmit timeslot (such as Tx timeslot 4), followed by five timeslots, for example 5 Tx frame 202 time slots (plus the timing advance) followed by a next receive timeslot (again Rx timeslot 4). A time gap therefore exists between successive occurrences of the corresponding Rx and Tx timeslots. This characteristic is illustrated by FIG. 3, which shows an Rx timeslot 301 and its corresponding Tx timeslot 303 along a frame timeline 302. The time gap 304, denoted by “M” is time available for the mobile station to perform non-call related activities, such as measurements.

The mobile station in the embodiments will also have additional time when the mobile station does not need to transmit or receive in a TDMA frame. In this case, the mobile station may be in an idle mode or an idle frame. Thus, during the idle frame the mobile station searches for more information from the serving or other cells. As illustrated by FIG. 3, the mobile station gets the Rx timeslot 301 and the Tx timeslot 303 to receive and transmit information before the mobile station gets the time gap 304 to perform operations other than being involved in a call. The mobile station utilizes the time gap 304 to measure signal strengths of the neighboring cells. In one of the embodiments, the mobile station also gets the Rx time slot 301, as shown on the right of the time gap 304, to perform non-call related activities. As such, in some embodiments, the mobile station gets M+1 time slots to perform non-call related activities.

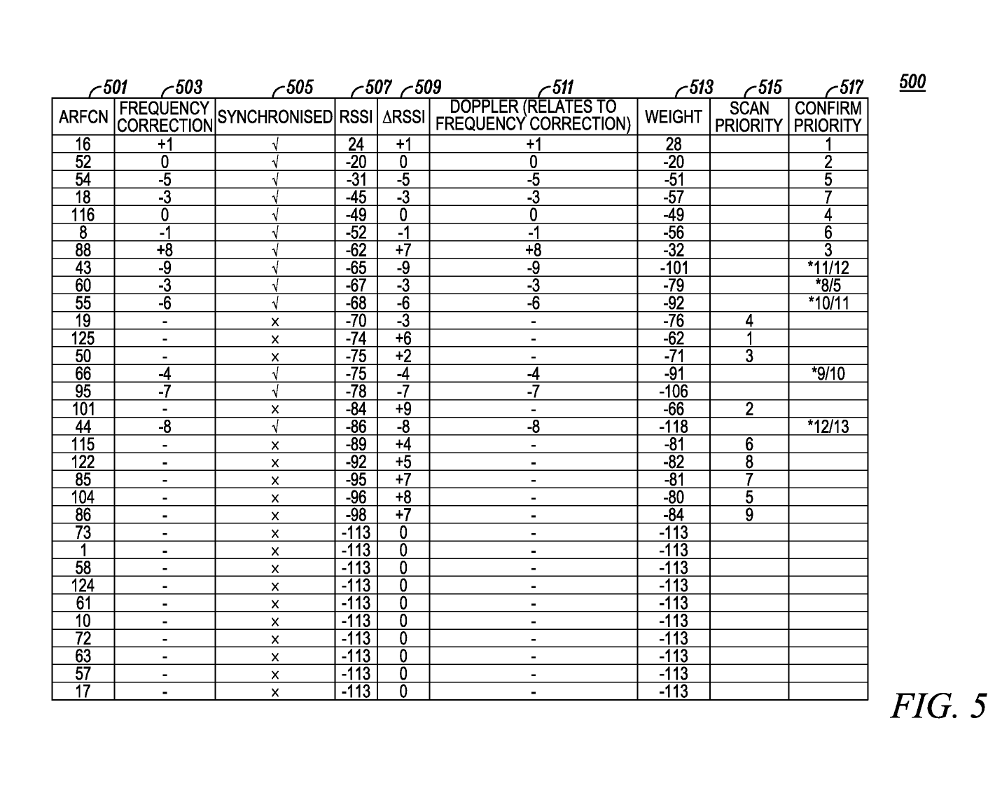

FIG. 4 illustrates a traffic channel (TCH) multi-frame 401 and a Broadcast Control Channel (BCCH) multi-frame 404 for further illustration of the timing involved in cell measurements by the mobile station. The TCH multi-frame 401 is a 26 frame repeating pattern of 12 TDMA frames for traffic followed by one TDMA frame (such as frame 402) for “Slow Associated Control Channel” (SACCH) frame or an idle frame. The idle frame or SACCH frame may be then followed by 12 TDMA frames for traffic, followed by one TDMA frame (such as frame 403) for idle frame or SACCH frame. The mobile station uses the idle frame to search for frequency correction bursts, synchronization bursts, and BCCH data from the BCCH carrier. In one of the embodiments, the mobile station gets an opportunity to search for frequency correction bursts and synchronization bursts, after every 25 frames. In one example, the TDMA frame 403 may be used by the mobile station to search for the frequency burst or the synchronization burst.

The BCCH multi-frame 404 is a 51 frame repeating pattern using Timeslot 0 of the TDMA frame. A Frequency Correction Burst 405 is sent in timeslots 0, 10, 20, 30 and 40 and a Synchronization Burst 406 is sent in timeslots 1, 11, 21, 31 and 41, as illustrated in FIG. 4. It can be seen in FIG. 4 that the frame being sent on any specific BCCH frame when the mobile station is receiving in the idle frame will follow a pattern n, n+26, n+1, n+27 . . . , for searching frequency correction bursts, synchronization bursts, and BCCH data.

The actual pattern of finding frequency and synchronization bursts on the BCCH frame will therefore be: F 1 S 6 F 1 S 8 F 1 S 6 F 1 S 8 . . . , where F corresponds to frequency correction burst, S corresponds to synchronization burst, and where 1, 6 and 8 are the number of frames without having interesting data. Operationally, the mobile station initiates the search for frequency correction bursts, for example the mobile station may find the bursts as F 8 F 10 F 8 F 10 . . . , and so on.

Because one TCH multi-frame is 26 TDMA frames the TCH multi-frame is 120 ms in length ((26×5×24)/26 ms)=120 ms. Therefore the mobile station searching for the frequency correction burst for a neighbor cell may spend, for example in a worst case, 1.2 s (10×120 ms) searching without finding any relevant information. The average number of search opportunities before the frequency correction burst may be found is (51/(5×2)) which takes 0.612 seconds. Thus, an average of 0.492 seconds is expended in searching and not finding any relevant information. The delay results from searching for frequency correction burst. Once a frequency correction burst is found by the mobile station, the mobile station knows that the synchronization burst will come in a next frame. The mobile station then decodes the synchronization bursts, and thus determines the BCCH frame timing. The mobile station may then dedicate only those search frames that coincide with the synchronization bursts, and confirm that it may still decode the cell.

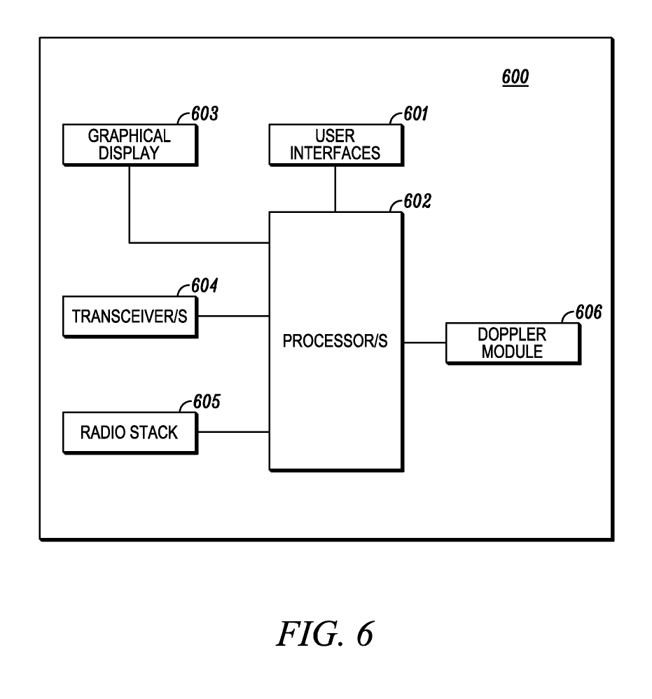

FIG. 5 illustrates a table corresponding to a neighbor list 500 in accordance with some embodiments. The neighbor list 500 illustrates a scenario, as described earlier herein with respect to FIG. 1. Column 501 refers to Absolute Radio Frequency Channel Numbers (ARFCN) of the neighbor cells. Column 503 refers to the frequency correction information and column 505 refers to the synchronization information. The frequency correction information is based on data from the mobile station's historical position. Column 507 refers to the RSSI measurement information calculated by the mobile station. In one example, the RSSI information of the neighbor cells may be calculated by the mobile station using the idle frame opportunity.

Column 509 refers to a change in RSSI (Δ RSSI) or signal strength that the mobile station measures based on the change in the signal strength values of the neighbor cells. Based on the rapidly changing RSSI values for the neighbor cells, the mobile station can recognize that it is in the fast moving environment. This change is then recorded as Δ RSSI. The Δ RSSI value for each neighbor cell also depends on a position of the mobile station with respect to the neighbor cell. In one example, the Δ RSSI values for neighbor cells that are coming near to the mobile station are higher than of the neighbor cells that are left behind.

Column 511 refers to a Doppler effect that is estimated for every neighbor cell. As mentioned earlier, a positive Doppler for a neighbor cell depicts that the neighbor cell is coming near to the moving mobile station. In contrast, a negative Doppler depicts that the neighbor cell is left behind the moving mobile station. The Doppler effect calculated for every neighbor cell is related to the Frequency correction values, as shown by Column 503. In one example, based on the Doppler effect that the mobile station experiences, the mobile station applies the frequency correction values to correct the Doppler effect. Column 513 refers to a weighting factor that accounts for the signal strength values (Column 507), change in signal strength values or Δ RSSI (Column 509), and Doppler (Column 51 1). The mobile station based on the weighting factor value of a particular neighbor cell, assigns a priority for handover to the particular neighbor cell. Column 515 and Column 517 refer to Scan priority and Confirm Priority. Scan priority is assigned to the neighbouring cells that are not synchronized with the mobile station. For example, scab priority is a priority which is assigned based on the frequency correction values. Confirm priority is assigned to the neighboring cells that are already synchronized to the mobile station. The confirm priority is assigned to the neighboring cells based on the weighting factor calculated for each neighboring cell.

Operationally, after the mobile station measures the signal strength of the neighbor cell during the available time gap, such as “M”, as shown by FIG. 3. As the mobile station is constantly moving in the fast moving environment, the mobile station also takes into account the Δ RSSI values of the neighbor cells, which are either near to the mobile station or far from the mobile station. In this case, the mobile station calculates a Doppler and applies the frequency correction values to correct the Doppler effect of the neighbor cells. The mobiles station then calculates a weighting factor for each neighbor cell, taking into account the measured signal strength values, change in signal strengths, and the Doppler effect for that neighbor cell.

When the mobile station receives a synchronization burst from a particular neighbor cell, the mobile station will synchronize that neighbor cell based on its RSSI values, taking into account the Δ RSSI and the Doppler effect. The mobile station then updates the weighting factor for the synchronized cell and then assigns a higher confirm priority to the neighbor cell that have a positive or higher Doppler effect, in contrast to the neighbor cell that has a negative or lower Doppler effect. The mobile station in this case will have a better chance of successful handover to a candidate neighbor cell or a target neighbor cell that may most likely be approaching the mobile station (or the mobile station will in fact be approaching the target neighbor cell neighbor), in accordance with some embodiments. For the neighbor cells that are not synchronized and no frequency correction value is available, the mobile station will assign a Scan priority based on the signal strength values, taking into account the Δ RSSI and weighting factor. The weighting factor for the neighbor cells that are not synchronized is calculated based on the signal strengths and Δ RSSI.

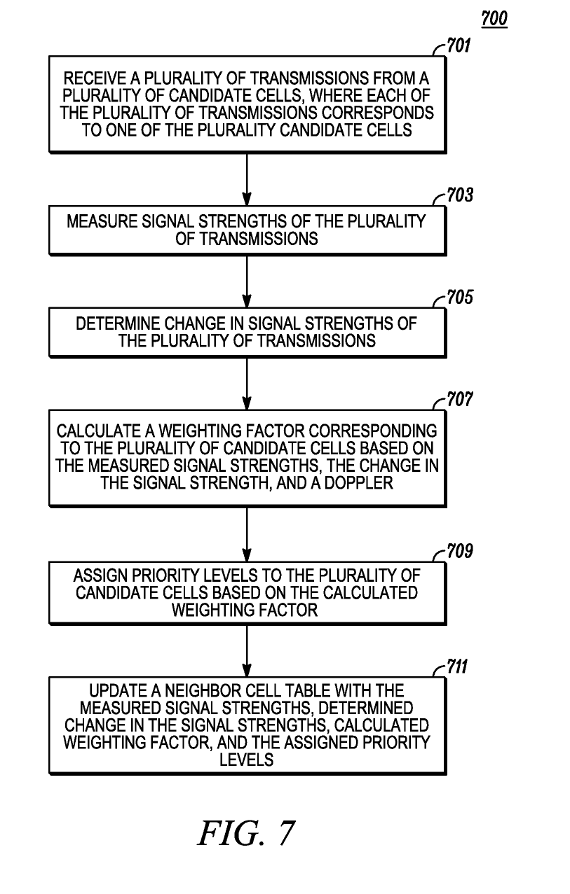

FIG. 6 illustrates a block diagram 600 of a mobile station in accordance with some embodiments. The mobile station comprises components as known by those of ordinary skill such as, but not limited to, user interfaces 601, a graphical display 603, transceiver/s 604, processor/s 602, and one or more radio stacks 605 for communicating over the air interface. The mobile station of the embodiments however will also comprise the neighbor list 500 as illustrated by FIG. 5, and a Doppler module 606 which performs the Doppler effect and weighting calculations necessary to populate the weight 513 and the Doppler effect 511, and other related fields of the neighbor list 500.

In one of the embodiments, the processor 602 or a processing unit 602 is communicatively coupled to the transceiver 604. In this case, the processing unit 602 is adapted to receive, via the transceiver, a plurality of transmissions from a plurality of candidate cells, where each of the plurality of transmissions corresponds one of the plurality candidate cells. The processing unit 602 measures signal strengths of the plurality of transmissions and determines change in signal strengths of the plurality of transmissions based on a change of position of the mobile station. In one example, the change in signal strengths may also be based on a change in position of the neighbor cell. The processing unit 602 calculates a weighting factor corresponding to the plurality of candidate neighbor cells based on the measured signal strength, Δ RSSI, and a Doppler effect. The processing unit 602 assigns priority levels to the plurality of candidate cells based on the calculated weighting factor.

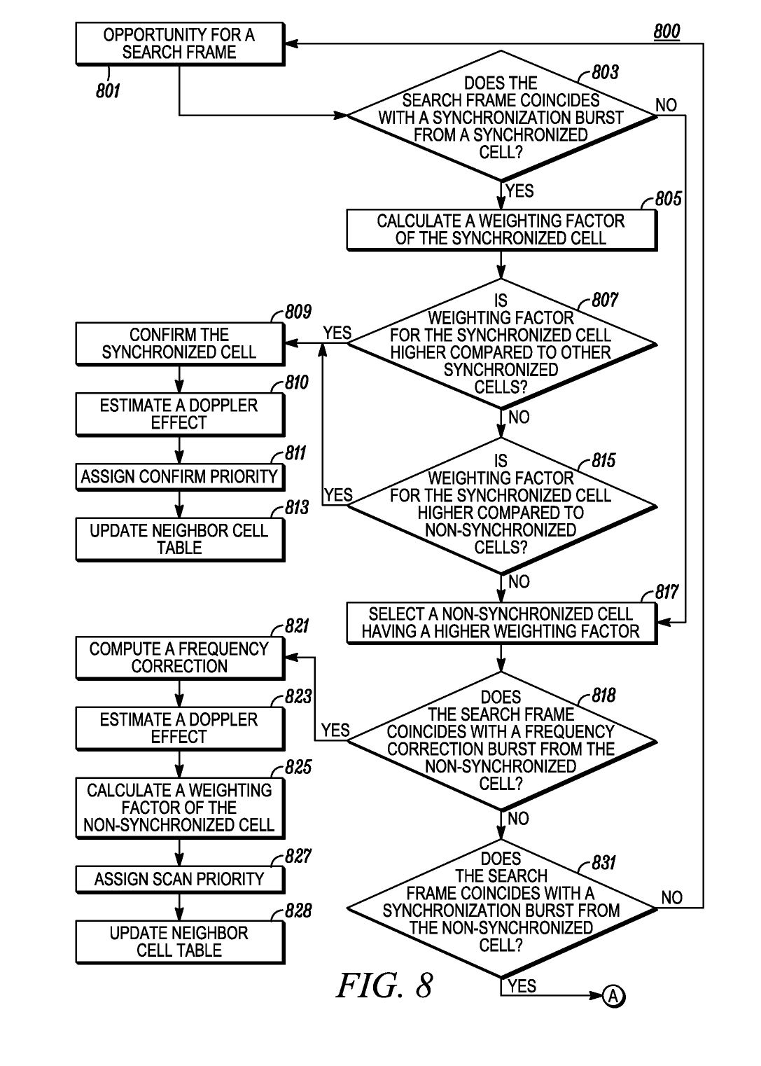

Turning now to FIG. 7 a flow diagram 700 of a method describing a basic operation of the mobile station of FIG. 6 in accordance with some embodiments. The method generally comprises receiving a plurality of transmissions from a plurality of candidate cells, where each of the plurality of transmissions corresponds to one of the plurality candidate cells (701). In one example, the transceiver 604 receives the plurality of transmissions from the plurality of candidate cells. The signal strengths of the plurality of transmissions are measured (703) and a change in signal strengths of the plurality of transmissions is determined (705). In one example, the processor 602 may measure the signal strengths and the change in signal strengths. Thereafter, a weighting factor corresponding to the plurality of candidate cells is calculated (707).

This calculated weighting factor is based on the measured signal strengths, the change in the signal strengths, and a Doppler effect. Based on the calculated weighting factor, different priority levels are assigned (709) to the candidate neighbor cells. In this case, the neighbor cell that has a higher weighting factor, with a positive or higher Doppler effect, and strong signal strength is assigned higher priority for handover, in contrast to the neighbor cell that has a lower weighting factor, with a negative or lower Doppler effect, and weak signal strength. This will help the mobile station to conduct a successful handover with the neighbor cells that are near to the mobile station and have strong signal strengths. Thereafter, a neighbor cell table is updated (711) with the measured signal strengths, determined change in the signal strengths, calculated weighting factor, and the assigned priority level. The neighbor cell table may also be updated with various other measured and calculated values that relate to the selection of the neighbor cells by the mobile station for a successful handover.

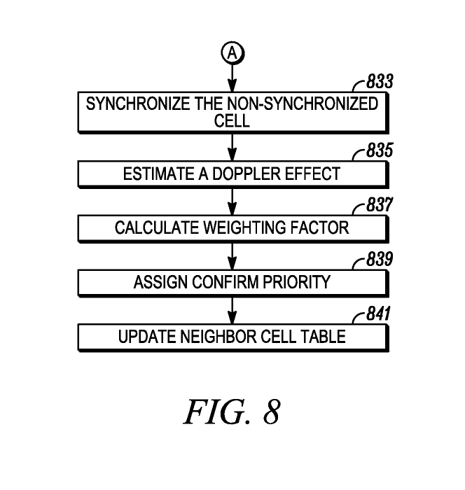

FIG. 8 illustrates a more detailed flow diagram 800 corresponding to the flow diagram 700 and describing a detailed operation of the mobile station of FIG. 6 in accordance with some embodiments. The mobile station identifies an opportunity for a search frame (801). In one example, the mobile station may receive this opportunity once every 25 TDMA frames. The mobile station may then determine that whether the search frame coincides with a synchronization burst, received from a neighbor cell that is already synchronized, known as a synchronized cell (803). The synchronization burst is received over a BCCH multi-frame of the synchronized cell. If the mobile station determines that the search frame coincides with the synchronization burst, the mobile station then calculates a weighting factor for the synchronized cell (805).

The mobile station may then determine whether the weighting factor calculated for the synchronized cell is higher compared to other synchronized cells (807). The synchronized cell is confirmed by the mobile station, if the weighting factor for the synchronized cell is higher compared to the other synchronized cells (809). The mobile station then estimates a Doppler effect for the synchronized cell (810) and assigns confirm priority based on the weighting factor of the neighbor cell (811). The neighbor cell table is then updated with the weighting factor and the confirm priority assigned to the neighbor cell (813).

The mobile station determines whether the weighting factor of the synchronized cell is higher compared to non-synchronized cells, if the mobile station determines that the weighting factor for the synchronized cell is lower as compared to other synchronized cells (815). The mobile station confirms the synchronized cell, if the weighting factor for the synchronized cell is higher compared to the non-synchronized cells (808). The mobile station then assigns confirm priority based on the weighting factor of the neighbor cell (811). The neighbor cell table is then updated with the weighting factor and the confirm priority (813).

The mobile station selects a non-synchronized cell that has a higher weighting factor, after the mobile station determines that the weighting factor for the synchronized cell is lower compared to the non-synchronized cells (817). The mobile station, after determining that the search frame does not coincides with the synchronization burst from the synchronized cell (803); the mobile station selects the non-synchronized cell having a higher weighting factor. The mobile station then determines whether the search frame coincides with a frequency burst from the non-synchronized cell (818).

The mobile station computes a frequency correction for the non-synchronized cell (821), if the mobile station that the search frame coincides with a frequency burst for the non-synchronized cell (818). The computation of the frequency correction is based on a frequency of a transmission received from the synchronized cell. The mobile station then estimates a Doppler effect (823) and calculates a weighting factor for the non-synchronized cell (825).

The mobile station based on the signal strength of the signal received from the neighbor cell and the frequency correction, and taking into account Δ RSSI and the estimated Doppler effect, assigns a scan priority to the neighbor cell (827). The mobile station thereafter updates the neighbor cell table with the frequency correction, the weighting factor, and the Doppler effect (828).

The mobile station determines whether the search frame coincides with synchronization burst from the non-synchronized cell (831), if the mobile station determines that the search frame does not coincides with the frequency correction burst from the non-synchronized cell (818). The mobile station then synchronizes the non-synchronized cell, if the search frame coincides with the synchronization burst from the non-synchronized cell (833). In one example, the synchronization of the non-synchronized cell may also depend upon the signal strengths and change in strengths of the signals received from the non-synchronized cells.

The mobile station then estimates a Doppler effect for the synchronized cell (835), calculates a weighting factor (837), assigns a confirm priority (839), and then updates the neighbor cell table (841) with the synchronization details. The mobile station waits for another opportunity for a search frame, if the search frame does not coincide with the synchronization burst from the non-synchronized cell (831).

In one of the embodiments, a mobile station measures RSSI for a neighbor cell in between a Tx burst and a Rx burst. In this case, the mobile station may conduct 217 RSSI measurements per second. The mobile station only searches for the Base Station Identity Code (BSIC) in a search frame every 120 ms. The mobile station measures for the RSSI values when the mobile station does not have an opportunity for a search frame. Once the mobile station receives an opportunity for a search frame, the mobile station either utilizes the search frame for a neighbor cell that is already synchronized or for a neighbor that is not yet synchronized. After the mobile station synchronizes with the neighbor cell, the mobile station identifies that when will it receive a synchronization burst from the synchronized cell, in order to assign a confirm priority to the synchronized cell. In this case, the mobile station may also check whether the synchronized cell is still a candidate for a handover, or the signal strength for the synchronized cell has reduced.

Further, when the mobile station searches for a neighbor cell that is not synchronized, the mobile station dedicates every search frame to search for a non-synchronized cell that would possibly be a candidate for a successful handover. This may be identified by measuring RSSI, Δ RSSI, a Doppler effect, and a frequency correction value for the non-synchronized cell. In one example, the mobile station may spend 11 search frames searching for a possible non-synchronized candidate cell. This may be repeated until the mobile station identifies a possible non-synchronized candidate cell for a successful handover.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for candidate cell evaluation by a mobile station in a fast moving environment, the method comprising:
receiving a plurality of transmissions from a plurality of candidate cells, wherein each of the plurality of transmissions corresponds to one of the plurality candidate cells;
measuring signal strengths of the plurality of transmissions;
determining change in the signal strengths of the plurality of transmissions;
calculating a weighting factor corresponding to the plurality of candidate cells based on the measured signal strengths, the change in the signal strength, and a Doppler; and
assigning priority levels to the plurality of candidate cells based on the calculated weighting factor.

2. The method of claim 1, further comprising:
updating a neighbor cell table with the measured signal strengths, determined change in the signal strengths, calculated weighting factor, and the assigned priority levels.

3. The method of claim 2, further comprising:
identifying an opportunity for a search frame; and
determining that the search frame coincides with a synchronization burst of the plurality of transmissions received from a synchronized cell of the plurality of candidate cells.

4. The method of claim 3, further comprising:
calculating the weighting factor for the synchronized cell, if the search frame coincides with the synchronization burst.

5. The method of claim 4, further comprising:
determining whether the weighting factor for the synchronized cell is higher compared to other synchronized cells of the plurality of candidate cells.

6. The method of claim 5, further comprising:
confirming the synchronized cell, if the weighting factor for the synchronized cell is higher compared to other synchronized cells;
assigning a confirm priority based on the weighting factor; and
updating the neighbor cell table with the weighting factor and the confirm priority for the synchronized cell.

7. The method of claim 5, further comprising:
determining whether the weighting factor for the synchronized cell is higher compared to other non-synchronized cells of the neighbor cell table, if the weighting factor for the synchronized cell is not higher compared to other synchronized cells.

8. The method of claim 7, further comprising:
confirming the synchronized cell, if the weighting factor for the synchronized cell is higher compared to other non-synchronized cells;
assigning a confirm priority based on the weighting factor; and
updating the neighbor cell table with the weighting factor and the confirm priority for the synchronized cell.

9. The method of claim 7, further comprising:
selecting a non-synchronized cell having a higher weighting factor compared to the other non-synchronized cells of the neighbor cell table, if the weighting factor for the synchronized cell is not higher compared to other non-synchronized cells.

10. The method of claim 9, further comprising:
determining whether a frequency correction burst is received for the non-synchronized cell.

11. The method of claim 10, further comprising:
computing a frequency correction based on a frequency of a transmission received from the synchronized cell, if the frequency correction burst is received from the non-synchronized;
estimating the Doppler for the non-synchronized cell;
calculating the weighting factor for the non-synchronized cell;
assigning a scan priority to the non-synchronized cell based on the weighting factor; and
updating the neighbor cell table with the frequency correction, the Doppler, the weighting factor, and the scan priority for the synchronized cell

12. The method of claim 10, further comprising:
determining that a synchronization burst is received from the non-synchronized cell, if the frequency correction burst is not received from the non-synchronized cell.

13. The method of claim 12, further comprising:
synchronizing the non-synchronized cell; and
updating the neighbor cell table with the synchronization of the non-synchronized cell.

14. A mobile station, comprising:
a transceiver;
a processor unit, communicatively coupled to the transceiver, that is:
adapted to receive, via the transceiver, a plurality of transmissions from a plurality of candidate cells, wherein each of the plurality of transmissions corresponds one of the plurality candidate cells;
adapted to measure, signal strengths of the plurality of transmissions;
adapted to determine, change in the signal strengths of the plurality of transmissions;
adapted to calculate, a weighting factor corresponding to the plurality of candidate cells based on the measured signal strength, the change in the signal strengths, and a Doppler effect; and
adapted to assign, priority levels to the plurality of candidate cells based on the calculated weighting factor.

15. The mobile station of claim 14, wherein the processor unit is further adapted to update a neighbor cell table with the measured signal strengths, determined change in the signal strengths, calculated weighting factor, and the assigned priority levels.
